(19) United States
(12) Patent Application Publication
(10) Pub. No.: US 2011/0138922 A1
(43) Pub. Date: Jun. 16, 2011

(54) SCUBA DIVING AIR TANK GAUGE

(76) Inventor: Emilio Allemano, Torino (IT)

(21) Appl. No.: 12/995,727

(22) PCT Filed: Jun. 1, 2009
(86) PCT No.: PCT/IB2009/005789

§ 371 Date: Feb. 28, 2011

(30) Foreign Application Priority Data
Jun. 3, 2008 (IT) TO2008A000421

(51) Int. Cl. G01L 7/04

(52) U.S. Cl. 73/732

(57) ABSTRACT

A scuba diving air tank gauge, wherein a casing made of plastic material has a transparent cover, and a radial inlet fitting integral with the casing and also made of plastic material, and houses a Bourdon gauge device, a closed metal tube of which is wound into a coil and has a straight inlet end portion that engages a conduit in the radial inlet fitting in sliding manner; the conduit having a cavity housing at least one O-ring; and the straight inlet end portion engaging the conduit and the cavity in axially sliding manner, and extending in fluidtight manner through the O-ring.

### TECHNICAL FIELD

The present invention relates to a scuba diving air tank gauge.

More specifically, the present invention relates to a gauge for measuring the air pressure in a scuba diving air tank, and of the type comprising a casing having an inlet fitting integral with the casing, and a conduit connectable to the tank; a Bourdon gauge device, in turn comprising a closed metal tube for receiving pressurized air from the tank; and a transparent cover closing the casing; the casing and the inlet fitting being formed in one piece from molded plastic material.

### BACKGROUND ART

Because scuba diving air tanks can contain air at an initial pressure of 300-400 atmospheres, using plastic material for the casing and inlet fitting of gauges of the above type poses various problems, on account of the difficulty in achieving fluidtight connection of the closed tube (metal) and the inlet fitting conduit (non-metal), and the fact that it is still practically impossible to produce a plastic casing with an inlet fitting capable of withstanding the internal pressure to which the fitting is normally subjected.

### DISCLOSURE OF INVENTION

It is an object of the present invention to provide a gauge of the above type, which is cheap and easy to produce and, at the same time, provides for resolving the above problems.

According to the present invention, there is provided a scuba diving air tank gauge as claimed in Claim 1 and preferably any one of the Claims depending directly or indirectly on Claim 1.

### BRIEF DESCRIPTION OF THE DRAWINGS

A number of non-limiting embodiments of the present invention will be described by way of example with reference to the accompanying drawings, in which:

FIG. 1 shows a plan view of a first preferred embodiment of the gauge according to the present invention;

FIG. 2 shows a longitudinal section along line II-II of the FIG. 1 gauge;

FIG. 3 shows a larger-scale view of a first detail in FIG. 2;

FIG. 4 shows a larger-scale plan view of a second detail in FIG. 2;

FIG. 5 shows a larger-scale underside view in perspective of a third detail in FIG. 2;

FIG. 6 shows a larger-scale view of a fourth detail in FIG. 2;

FIG. 7 shows a longitudinal section of a second preferred embodiment of the gauge according to the present invention;

FIG. 8 shows a larger-scale view of a detail in FIG. 7.

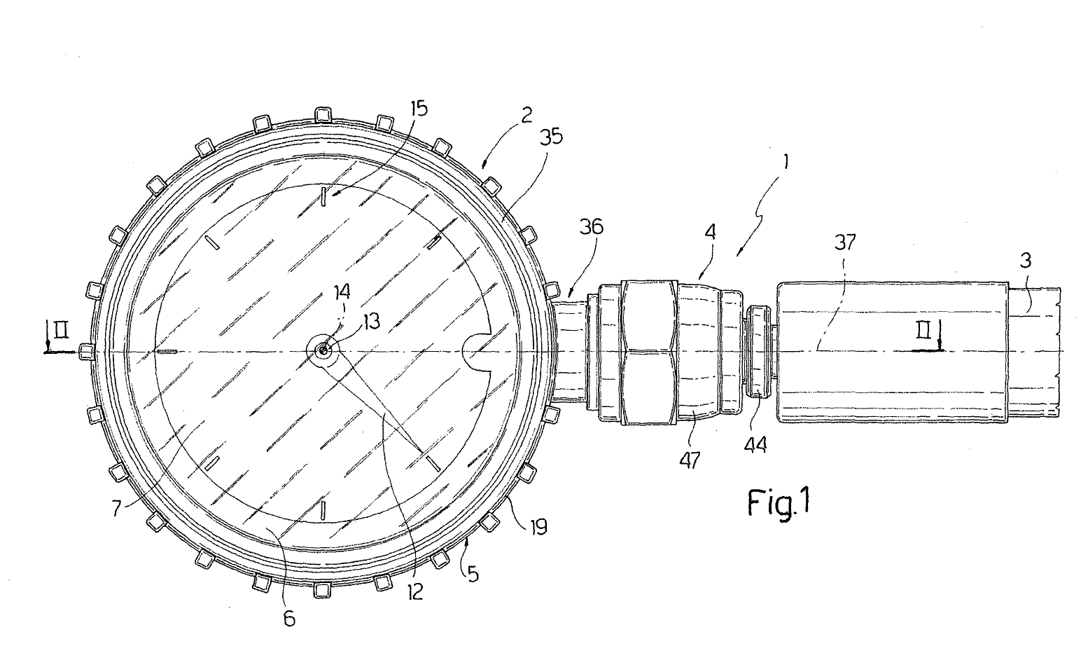

### BEST MODE FOR CARRYING OUT THE INVENTION

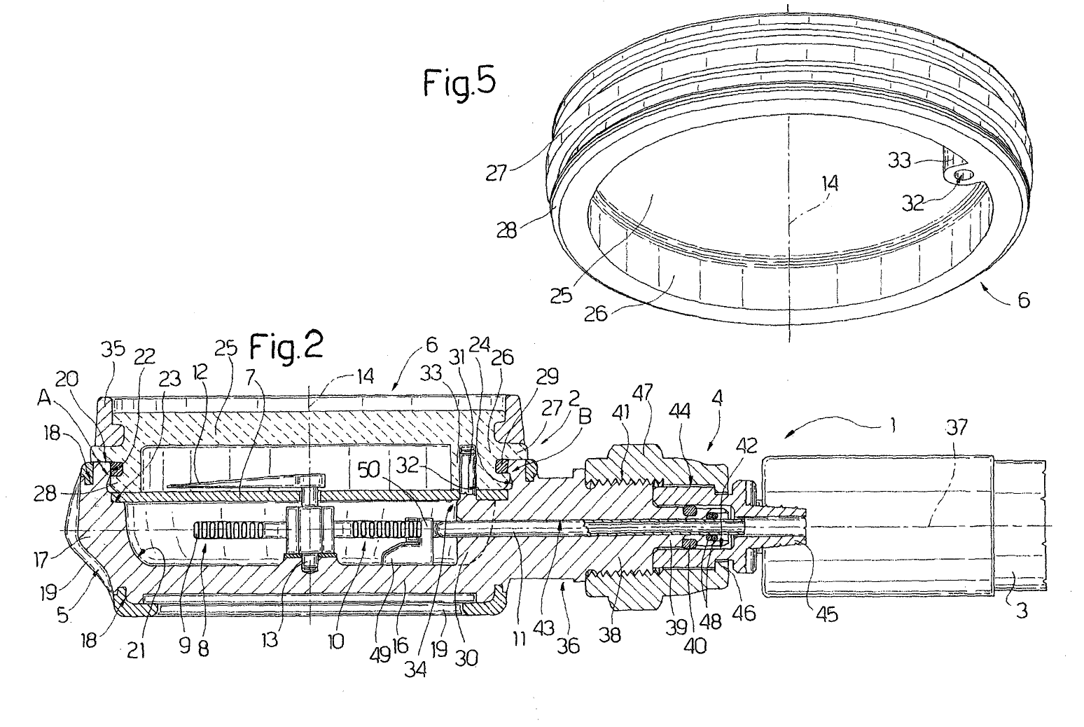

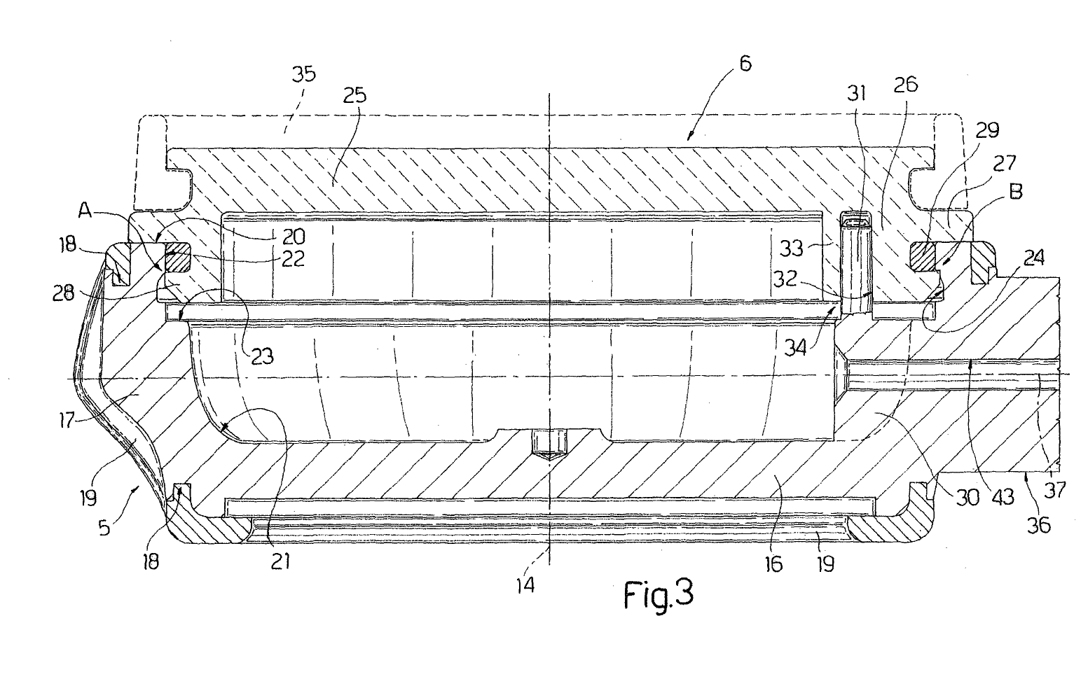

With particular reference to FIG. 2, number 1 indicates as a whole a gauge wand for a scuba diving air tank (not shown). Wand 1 comprises a gauge 2; and a hose 3 connectable at one end to the tank (not shown), and having, at the other end, an outlet fitting 4 for connecting gauge 2 removably and in rotary and fluidtight manner to hose 3.

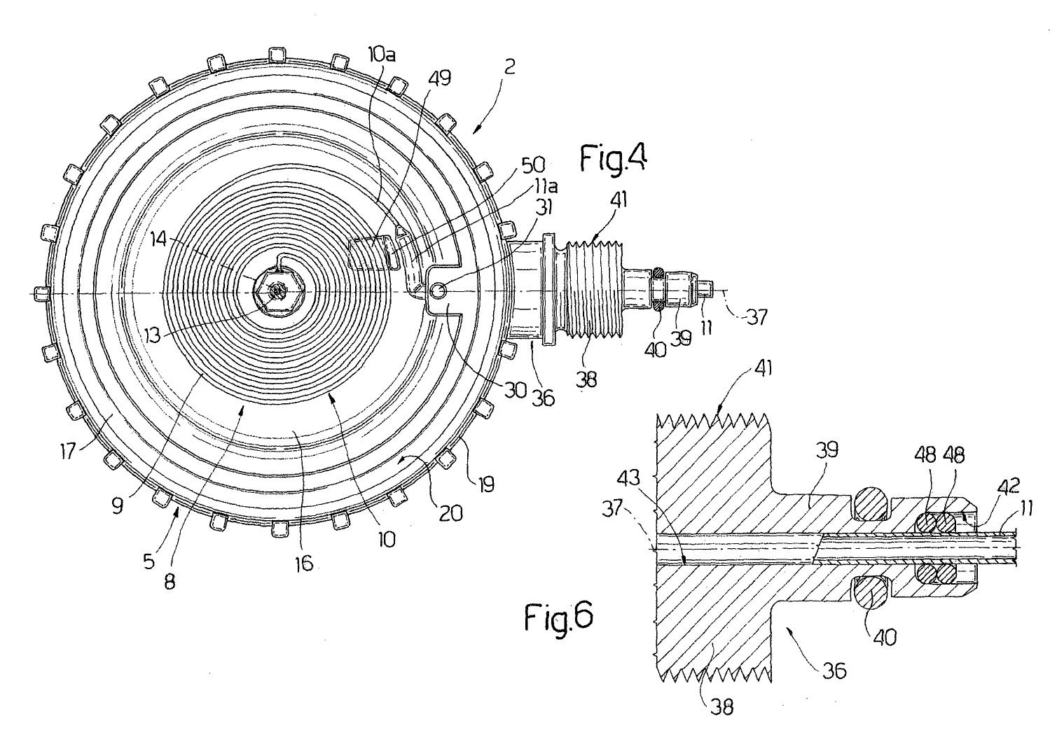

Gauge 2 comprises a cup-shaped casing 5 made of plastic material, closed by a transparent cover 6, and housing a dial 7 facing transparent cover 6. Casing 5 also houses a Bourdon gauge device 8 comprising a closed metal tube 9 wound into a coil 10, along which the closed tube 9 is flattened. With reference to FIGS. 2 and 4, coil 10 is parallel to dial 7, has an outer turn 10a spaced apart from the others, and, at the end connected to the air tank (not shown), has a straight inlet end portion 11 extending substantially radially with respect to coil 10. Straight portion 11 has a circular cross section, and is connected to a circular-cross-section inlet portion 11a of outer turn 10a.

Gauge device 8 also comprises a needle 12 fitted to a shaft 13, which is fitted to casing 5 to rotate about a longitudinal axis 14 of casing 5, and defines an output of gauge device 8. Shaft 13 is connected to a closed end of coil 10 opposite the end fitted with straight portion 11, and needle 12 is visible from the outside through transparent cover 6, and is moved by coil 10 along a scale 15 of pressure values marked on dial 7 to indicate, on scale 15, the remaining pressure inside the air tank.

Casing 5 comprises a bottom wall 16 crosswise to axis 14; and a substantially cylindrical outer lateral wall 17, each free end of which has a front annular groove 18 for attaching to casing 5 a relatively soft plastic covering 19 co-molded with casing 5 and for covering a peripheral portion of bottom wall 16 and lateral wall 17, which is bounded at its free end by a flat annular surface 20 parallel to bottom wall 16 and coaxial with axis 14.

Casing 5 is bounded internally by a cup-shaped bottom surface 21, which is connected to annular surface 20 by a cylindrical surface 22 coaxial with axis 14, larger in diameter than the maximum diameter of bottom surface 21, and forming, with the open end of bottom surface 21, a flat annular shoulder 23 coaxial with axis 14, parallel to annular surface 20, and supporting the outer periphery of dial 7.

An annular groove 24 is formed along cylindrical surface 22, is coaxial with axis 14, and serves to click transparent cover 6 onto casing 5.

Transparent cover 6, which is made of thermoplastic material, is cup-shaped, is positioned with its concavity facing the concavity of casing 5, and comprises a substantially circular front wall 25; and a cylindrical lateral wall 26, which has an outer annular intermediate flange 27 coaxial with axis 14 and resting on annular surface 20, and an annular end tooth 28 which is parallel to intermediate flange 27, forms with intermediate flange 27 an annular groove housing a seal engaging cylindrical surface 22, and clicks inside annular groove 24.

Tooth 28 is bounded at its free end by a circular edge, which is slightly offset with respect to axis 14, so that there is minimum engagement of annular groove 24 by tooth 28 at a point A of its periphery, and maximum engagement of annular groove 24 at a point B, diametrically opposite point A, of its periphery.

A projection 30 at point B projects radially inwards from bottom surface 21, is bounded outwards by a flat surface coplanar with annular shoulder 23, and has a pin 31 which extends, parallel to axis 14, from projection 30, and engages a through hole formed through dial 7, and a dead hole 32 formed in a radial projection 33 projecting inwards from lateral wall 26 and facing projection 30.

Together with dead hole 32 and pin 31, tooth 28 defines a cover 6 burst-inhibiting device 34, i.e. a device for preventing cover 6 from detaching completely from casing 5.

Transparent cover 6 has a safety ring 35 made of relatively soft plastic material and attached to the outer surface of lateral wall 26, outwards of intermediate flange 27; and casing 5 has an inlet fitting 36 made of plastic material, integral with casing 5, and extending outwards from lateral wall 17 along an axis 37 radial with respect to axis 14 and through projection 30.

In a variation not shown, burst-inhibiting device 34 may be replaced by a burst-inhibiting device defined by safety ring 35, and by a further ring (not shown) made of plastic material, fitted to inlet fitting 36, and having a radial appendix (not shown) integral with the periphery of safety ring 35. In which case, pin 31 and dead hole 32 are eliminated.

As shown in FIGS. 2 and 6, inlet fitting 36 has an end portion 38 having a cylindrical end appendix 39, which is coaxial with axis 37 and end portion 38, and has an outer intermediate annular groove housing a seal 40. End portion 38 has an outside diameter larger than the outside diameter of appendix 39, and has a thread 41 on its outer surface; and appendix 39 defines the free end of inlet fitting 36, and has a cylindrical end cavity 42 coaxial with axis 37 and defining an outlet end of a conduit 43 coaxial with axis 37 and extending along the whole of inlet fitting 36 and projection 30 to connect the inside of casing 5 to hose 3 via fitting 4, which engages thread 41 to connect gauge 2 removably and in fluidtight and rotary manner to hose 3.

Accordingly, outlet fitting 4 comprises a socket 44, the inner chamber of which communicates through its end wall with a tubular appendix 45 fitted inside hose 3, and houses appendix 39 and seal 40 in fluidtight manner. On its outer surface, socket 44 has an annular groove engaged in rotary manner by an inner flange 46 of a sleeve 47, which is partly engaged in rotary manner by socket 44, and has an internally threaded portion that projects from an end edge of socket 44 and engages external thread 41 of end portion 38 of inlet fitting 36.

As shown more clearly in FIG. 2, straight portion of closed tube 9 engages conduit 43 in axially sliding manner, extends through cylindrical cavity 42, and comes out, at one end, outside cylindrical cavity 42 to engage, in use, tubular appendix 45 of socket 44.

As shown more clearly in FIGS. 2 and 6, the part of straight portion 11 of closed tube 9 inside cylindrical cavity 42 is fitted with two superimposed O-rings 48 housed inside cylindrical cavity 42, and one of which is optional.

As shown more clearly in FIGS. 2 and 4, the inner surface of bottom wall 16 of casing 5 is fitted with a bracket 49 having a curved appendix 50, which extends towards dial 7 through coil 10, in the gap between outer turn 10a and the rest of coil 10. Bracket 49 and appendix 50 define a stop device, which cooperates with inlet portion 11a of outer turn 10a to prevent straight portion 11 from sliding axially, or at least by more than a relatively small amount, inwards of casing 5 along conduit 43.

In actual use, when gauge 2 is connected to hose 3, the pressurized air in the tank (not shown) acts solely on the free end of straight portion 11 of closed tube 9, and on the inner surface of cylindrical cavity 42 left clear by O-rings 48, which, pressing against the inlet of conduit 43, prevent pressurized air from flowing into casing 5 along the tubular gap defined by straight portion 11 inside conduit 43, and prevent both inlet fitting 36 and casing 5 from being subjected to any internal pressure, thus enabling gauge 2 to be made of molded plastic material.

In connection with the above, it should be pointed out that the internal forces acting on cylindrical cavity 42 are absorbed by outlet fitting 4, and in particular by socket 44, whereas the axial forces acting on straight portion 11 are absorbed by appendix 50 of bracket 49.

In the event of a manufacturing defect allowing pressurized air to get past O-rings 48, the resulting internal pressure could cause gauge 2 to burst, thus seriously endangering the user. This is prevented, however, by burst-inhibiting device 34 which, in the event of pressurized air inside gauge 2, allows transparent cover 6 to tilt—without detaching, by virtue of being retained by pin 31—with respect to casing about point A, thus letting the air out.

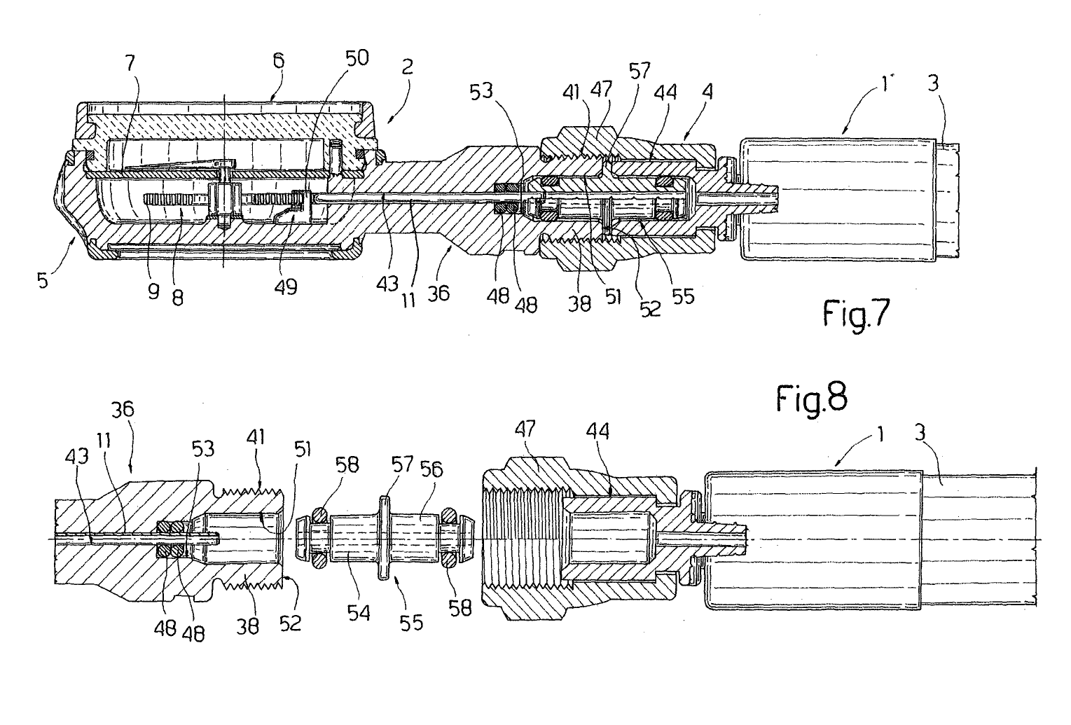

The FIGS. 7 and 8 embodiment differs from the one in the previous drawings by end portion 38 of inlet fitting 36 in FIGS. 7 and 8 having external thread 41 but no appendix 39, and conduit 43 comes out, at end portion 38, inside a cylindrical chamber 51, which is coaxial with axis 37 and communicates with the outside through a hole formed in a free end surface of end portion 38 and defining, on said end surface, an annular edge 52. At its inner end, cylindrical chamber 51 has an end portion 53, which connects cylindrical chamber 51 and conduit 43, is larger in diameter than conduit 43 and smaller in diameter than cylindrical chamber 51, and houses the two O-rings 48.

As shown more clearly in FIG. 8, straight inlet end portion 11 of closed tube 9 engages conduit 43, comes out at one end inside end portion 53 of cylindrical chamber 51, and engages the two O-rings 48.

Cylindrical chamber 51 is substantially identical in section to the inner chamber of socket 44, and is sized crosswise to receive a plug 54 of a two-plug tubular sealing member 55 normally made of metal material, and the other plug 56 of which, identical to, opposite, and coaxial with plug 54, is separated from plug 54 by a central outer flange 57. Like appendix 39, each plug 54, 56 has an outer annular groove engaged by an O-ring 58.

As shown in FIG. 7, plug 54 is inserted, in use, in fluidtight manner inside cylindrical chamber 51 so flange 57 contacts annular edge 52 of end portion 38; and plug 56 is inserted, in use, in fluidtight manner inside socket 44, the end edge of which presses flange against annular edge 52 when sleeve 47 is screwed onto thread 41.

1. A gauge for a scuba diving air tank, the gauge comprising a casing having an inlet fitting integral with the casing and in turn having a conduit connectable to the air tank; a Bourdon gauge device, in turn comprising a closed metal tube for receiving pressurized air from the air tank; and a transparent cover closing the casing; the casing and the inlet fitting being formed in one piece from molded plastic material; and the gauge being characterized in that the closed metal tube comprises a straight inlet end portion; the conduit communicates with a cavity, and sealing means are housed in the cavity, the straight inlet end portion engaging the conduit and the cavity in axially sliding manner, and extending in fluidtight manner through the sealing means.

2. A gauge as claimed in claim 1, wherein the sealing means comprise at least one O-ring fitted to the straight inlet end portion to separate the cavity from the conduit in fluidtight manner.

3. A gauge as claimed in claim 1, wherein the cavity is formed axially in a free end of the inlet fitting, and is open outwards.

4. A gauge as claimed in claim 1, wherein the casing has a first axis; and the inlet fitting extends along a second axis radial with respect to the first axis, and comprises an end portion having an external thread that engages an internal thread of a rotary sleeve of an outlet fitting of a hose connecting the gauge to the air tank.

5. A gauge as claimed in claim 4, wherein the external thread is integral with the end portion of the inlet fitting, and is made of plastic material.

6. A gauge as claimed in claim 4, and comprising a cylindrical appendix extending along the second axis from a free end of the end portion; the cavity being coaxial with the second axis and formed in a free end of the appendix; and the appendix being inserted in fluidtight manner inside an outlet fitting of a hose connecting the gauge to the air tank.

7. A gauge as claimed in claim 6, wherein the cylindrical appendix has an outer annular groove for housing a seal.

8. A gauge as claimed in claim 4, wherein the cavity is coaxial with the second axis and formed in a free end of the end portion.

9. A gauge as claimed in claim 8, wherein the cavity is sized to receive a first plug of a two-plug tubular sealing member, a second plug of which, opposite the first, is inserted in fluidtight manner inside an outlet fitting of a hose connecting the gauge to the air tank.

10. A gauge as claimed in claim 1, and comprising stop means housed inside the casing to prevent the straight inlet end portion, in use, from sliding, beyond a given position, along the conduit towards the casing.

11. A gauge as claimed in claim 10, wherein the closed metal tube of the Bourdon gauge device comprises a coil having a number of turns, and an outer turn of which is spaced apart from the others and connected to the straight inlet end portion; said stop means being interposed in a gap between the outer turn and the rest of the coil.

12. A gauge as claimed in claim 1, wherein click-on connecting means are provided to connect the casing and the transparent cover to each other.

13. A gauge as claimed in claim 12, and comprising a burst-inhibiting device for preventing the gauge from bursting; the burst-inhibiting device preventing full detachment of the transparent cover from the casing; and the click-on connecting means forming part of the burst-inhibiting device.

14. A gauge as claimed in claim 12, wherein the casing has an axis, and the click-on connecting means comprise a groove formed on the casing coaxially with the axis; and an annular tooth, which is carried by the transparent cover, clicks inside the groove, and is eccentric with respect to the axis, so as to have a first point of minimum engagement and a second point of maximum engagement of the groove.

15. A gauge as claimed in claim 14, wherein the burst-inhibiting device also comprises a pin integral with the casing, parallel to the axis, and engaging a dead hole formed in the transparent cover, close to the second point.
